(19) United States
(12) Patent Application Publication
(10) Pub. No.: US 2025/0374342 A1
(43) Pub. Date: Dec. 4, 2025

(54) RADIO LINK ESTABLISHMENT METHOD, INFORMATION TRANSMISSION METHOD AND APPARATUS, AND LAYER 1 FORWARDING NODE

(71) Applicant: VIVO MOBILE COMMUNICATION CO., LTD., Dongguan (CN)

(72) Inventor: Jinhua LIU, Dongguan (CN)

(73) Assignee: VIVO MOBILE COMMUNICATION CO., LTD., Dongguan (CN)

(21) Appl. No.: 19/300,639

(22) Filed: Aug. 14, 2025

Related U.S. Application Data
(63) Continuation of application No. PCT/CN2024/076514, filed on Feb. 7, 2024.

(30) Foreign Application Priority Data
Feb. 14, 2023 (CN) 202310124054.8

(51) Int. Cl. H04W 76/10; H04L 43/10; H04W 76/20

(52) U.S. Cl. CPC H04W 76/10; H04L 43/10; H04W 76/20

(57) ABSTRACT

This application discloses a radio link establishment method, an information transmission method and apparatus, and a layer 1 forwarding node. The radio link establishment method includes: when a terminal module is in a first state, in response to a forwarding function of a forwarding unit being configured to be completely or partially enabled, initiating, by the terminal module, radio link establishment when meeting a first condition, where the terminal module and the forwarding unit belong to a same layer 1 forwarding node, the first state includes a radio resource control (RRC) idle state or an RRC inactive state, and the meeting a first condition includes at least one of the following: the layer 1 forwarding node being abnormal, or a network-side device configuring or pre-configuring the terminal module to initiate radio link establishment.

### CROSS-REFERENCE TO RELATED APPLICATIONS

This application is a continuation of International Application No. PCT/CN2024/076514, filed Feb. 7, 2024, which claims priority to Chinese Patent Application No. 202310124054.8, filed Feb. 14, 2023. The entire contents of each of the above-referenced applications are expressly incorporated herein by reference.

### TECHNICAL FIELD

This application belongs to the technical field of communication, and in particular, to a radio link establishment method, an information transmission method and apparatus, and a layer 1 forwarding node.

### BACKGROUND

In a related technology, after a Network Controlled Repeater-Mobile Termination (NCR-MT) enters a Radio Resource Control (RRC) inactive (INACTIVE) state, an NCR Forwarding unit (NCR Forwarding, NCR-FWD) may continue forwarding. However, the NCR-MT cannot promptly determine entry into an RRC connected (CONNECTED) state, the NCR-MT cannot report state information thereof to a base station, and the base station cannot promptly send a forwarding configuration to the NCR-MT. Consequently, the NCR continues to use a suboptimal forwarding configuration. In this way, performance of forwarding a target signal by the NCR-FWD is degraded, thereby causing useless forwarding, generation of an interference signal, or failure to forward all or part of the target signal.

### SUMMARY

Embodiments of this application provide a radio link establishment method, an information transmission method and apparatus, and a layer 1 forwarding node, which provides a radio link establishment procedure when an NCR-MT enters an RRC inactive or idle state and an NCR-FWD performs a forwarding behavior, enabling the NCR-MT to restore an RRC connected state in time. In this way, in the connected state, the NCR-MT can report state information thereof to a base station, receive a forwarding configuration from the base station, and the like, to improve performance of forwarding a target signal by the NCR-FWD.

According to a first aspect, a radio link establishment method is provided, the method including:
in a case that a terminal module is in a first state, if a forwarding function of a forwarding unit is configured to be completely or partially enabled, initiating, by the terminal module, radio link establishment when meeting a first condition, where the terminal module and the forwarding unit belong to a same layer 1 forwarding node, the first state includes a radio resource control RRC idle state or an RRC inactive state, and the meeting a first condition includes at least one of the following: the layer 1 forwarding node being abnormal, or a network-side device configuring or pre-configuring the terminal module to initiate radio link establishment.

According to a second aspect, a radio link establishment apparatus is provided, the apparatus including:
a terminal module, configured to initiate, in a first state, radio link establishment when meeting a first condition if a forwarding function of a forwarding unit is configured to be completely or partially enabled, where the terminal module and the forwarding unit belong to a same layer 1 forwarding node, the first state includes a radio resource control RRC idle state or an RRC inactive state, and the meeting a first condition includes at least one of the following: the layer 1 forwarding node being abnormal, or a network-side device configuring or pre-configuring the terminal module to initiate radio link establishment.

According to a third aspect, a forwarding configuration method is provided, the method including:
sending, by a network-side device, first information to a terminal module, the first information including at least one of the following:
first pre-configuration information, the first pre-configuration information being used for pre-configuring initiation of a radio link establishment procedure in a case that the terminal module is in a first state and a forwarding function of a forwarding unit is configured to be completely or partially enabled, where the terminal module and the forwarding unit belong to a same layer 1 forwarding node, and the first state includes a radio resource control RRC idle state or an RRC inactive state; or
second configuration information, the second configuration information being configured by the network-side device before the terminal module enters the first state, and the second configuration information being used for configuring wireless channels or resources for receiving side control information when the terminal module is in the first state.

According to a fourth aspect, a forwarding configuration apparatus is provided, the apparatus including:
a first sending module, configured to send first information to a terminal module, the first information including at least one of the following:
first pre-configuration information, the first pre-configuration information being used for pre-configuring initiation of a radio link establishment procedure in a case that the terminal module is in a first state and a forwarding function of a forwarding unit is configured to be completely or partially enabled, where the terminal module and the forwarding unit belong to a same layer 1 forwarding node, and the first state includes a radio resource control RRC idle state or an RRC inactive state; or
second configuration information, the second configuration information being wireless channels or resources that are configured by the network-side device before the terminal module enters the first state and are used for transmitting side control information.

According to a fifth aspect, an information transmission method is provided, the method including:
receiving, by a terminal module in a first state, side control information from a network-side device based on a configured PDCCH channel or a semi-statically configured PDSCH resource, where the first state includes a radio resource control RRC idle state or an RRC inactive state, the side control information is used for controlling a forwarding behavior of a forwarding unit, and the terminal module and the forwarding unit are located on a same layer 1 forwarding node.

According to a sixth aspect, an information transmission apparatus is provided, the apparatus including:
a terminal module, configured to receive, in a first state, side control information from a network-side device based on a configured PDCCH channel or a semi-statically configured PDSCH resource, where the first state includes a radio resource control RRC idle state or an RRC inactive state, the side control information is used for controlling a forwarding behavior of a forwarding unit, and the terminal module and the forwarding unit are located on a same layer 1 forwarding node.

According to a seventh aspect, a resource configuration method is provided, the method including:
sending, by a network-side device, third configuration information to a terminal module, the third configuration information being used for configuring: a PDCCH channel or a semi-statically configured PDSCH resource for the terminal module to receive side control information in a first state, where the first state includes a radio resource control RRC idle state or an RRC inactive state, the side control information is used for controlling a forwarding behavior of a forwarding unit, and the terminal module and the forwarding unit are located on a same layer 1 forwarding node.

According to an eighth aspect, a resource configuration apparatus is provided, the apparatus including:
a second sending module, configured to send third configuration information to a terminal module, the third configuration information being used for configuring: a PDCCH channel or a semi-statically configured PDSCH resource for the terminal module to receive side control information in a first state, where the first state includes a radio resource control RRC idle state or an RRC inactive state, the side control information is used for controlling a forwarding behavior of a forwarding unit, and the terminal module and the forwarding unit are located on a same layer 1 forwarding node.

According to a ninth aspect, a layer 1 forwarding node is provided, the layer 1 forwarding node including a processor and a memory, the memory storing a program or an instruction executable on the processor, and when the program or the instruction is executed by the processor, steps of the method according to the first aspect or the fifth aspect being implemented.

According to a tenth aspect, a layer 1 forwarding node is provided, including a processor and a communication interface;
where the communication interface is used for initiating, in a case that a terminal module is in a first state, if a forwarding function of a forwarding unit is configured to be completely or partially enabled, radio link establishment when a first condition is met, where the terminal module and the forwarding unit belong to a same layer 1 forwarding node, the first state includes a radio resource control RRC idle state or an RRC inactive state, and the meeting a first condition includes at least one of the following: the layer 1 forwarding node being abnormal, or a network-side device configuring or pre-configuring the terminal module to initiate radio link establishment;
or
the communication interface is used for receiving, in a case that the terminal module is in the first state, side control information from a network-side device based on a configured PDCCH channel or a semi-statically configured PDSCH resource, where the first state includes a radio resource control RRC idle state or an RRC inactive state, the side control information is used for controlling a forwarding behavior of a forwarding unit, and the layer 1 forwarding node includes the terminal module and the forwarding unit.

According to an eleventh aspect, a network-side device is provided, the network-side device including a processor and a memory, the memory storing a program or an instruction executable on the processor, and when the program or the instruction is executed by the processor, steps of the method according to the third aspect or the seventh aspect being implemented.

According to a twelfth aspect, a layer 1 forwarding node is provided, including a processor and a communication interface;
where the communication interface is configured to send first information to a terminal module, the first information including at least one of the following:
first pre-configuration information, the first pre-configuration information being used for pre-configuring initiation of a radio link establishment procedure in a case that the terminal module is in a first state and a forwarding function of a forwarding unit is configured to be completely or partially enabled, where the terminal module and the forwarding unit belong to a same layer 1 forwarding node, and the first state includes a radio resource control RRC idle state or an RRC inactive state; or
second configuration information, the second configuration information being configured by the network-side device before the terminal module enters the first state, and the second configuration information being used for configuring wireless channels or resources for receiving side control information when the terminal module is in the first state;
or
the communication interface is configured to send third configuration information to the terminal module, the third configuration information being used for configuring: a PDCCH channel or a semi-statically configured PDSCH resource for the terminal module to receive side control information in a first state, where the first state includes a radio resource control RRC idle state or an RRC inactive state, the side control information is used for controlling a forwarding behavior of a forwarding unit, and the terminal module and the forwarding unit are located on a same layer 1 forwarding node.

According to a thirteenth aspect, a readable storage medium is provided, the readable storage medium having a program or an instruction stored therein, when the program or the instruction is executed by a processor, steps of the method according to the first aspect or the third aspect or the fifth aspect or the seventh aspect being implemented.

According to a fourteenth aspect, a chip is provided, the chip including a processor and a communication interface, the communication interface being coupled to the processor, and the processor being configured to run a program or an instruction, to implement the method according to the first aspect or the third aspect or the fifth aspect or the seventh aspect.

According to a fifteenth aspect, a computer program/program product is provided, the computer program/program product being stored in a storage medium, and the computer program/program product being executed by at least one processor to implement steps of the method according to the first aspect or the third aspect or the fifth aspect or the seventh aspect.

In the embodiments of this application, in a case that a terminal module is in a first state, if a forwarding function of a forwarding unit is configured to be completely or partially enabled, the terminal module initiates radio link establishment when meeting a first condition, where the terminal module and the forwarding unit belong to a same layer 1 forwarding node, the first state includes a radio resource control RRC idle state or an RRC inactive state, and the meeting a first condition includes at least one of the following: the layer 1 forwarding node being abnormal, or a network-side device configuring or pre-configuring the terminal module to initiate radio link establishment. When an NCR-MT enters an RRC inactive or idle state and an NCR-FWD performs a forwarding behavior, by initiating a radio link establishment procedure, the NCR-MT can restore an RRC connected state in time. In this way, in the connected state, the NCR-MT can report state information thereof to a base station, receive a forwarding configuration from the base station, and the like, which can improve performance of forwarding a target signal by the NCR-FWD.

### BRIEF DESCRIPTION OF THE DRAWINGS

FIG. 1 is a schematic structural diagram I of a wireless communication system to which an embodiment of this application is applicable;

FIG. 2 is a schematic structural diagram II of a wireless communication system to which an embodiment of this application is applicable;

FIG. 3 is a flowchart of a radio link establishment method according to an embodiment of this application;

FIG. 4 is a flowchart of a forwarding configuration method according to an embodiment of this application;

FIG. 5 is a flowchart of an information transmission method according to an embodiment of this application;

FIG. 6 is a flowchart of a resource configuration method according to an embodiment of this application;

FIG. 7 is a schematic structural diagram of a radio link establishment apparatus according to an embodiment of this application;

FIG. 8 is a schematic structural diagram of a forwarding configuration apparatus according to an embodiment of this application;

FIG. 9 is a schematic structural diagram of an information transmission apparatus according to an embodiment of this application;

FIG. 10 is a schematic structural diagram of a resource configuration apparatus according to an embodiment of this application;

FIG. 11 is a schematic structural diagram of a communication device according to an embodiment of this application; and

FIG. 12 is a structural schematic diagram of a network-side device according to an embodiment of this application.

### DETAILED DESCRIPTION

The technical solutions in the embodiments of this application are clearly described in the following with reference to the accompanying drawings in the embodiments of this application. Apparently, the described embodiments are merely some rather than all of the embodiments of this application. Based on the embodiments in this application, all other embodiments obtained by a person of ordinary skill in the art fall within the protection scope of this application.

The terms “first”, “second”, and the like in this application are used to distinguish similar objects, but are not used to describe a specific order or sequence. It will be appreciated that the terms used in this way are exchangeable in a proper case, so that the embodiments of this application can be implemented in an order different from the order shown or described herein, and objects distinguished by “first” and “second” are usually of a same category and a quantity of the objects is not defined. For example, there may be one or more first objects. In addition, “or” in this specification and the claims represents at least one of connected objects. For example, “A or B” covers three solutions, i.e., Solution I: including A and excluding B; Solution II: including B and excluding A; and Solution III: including both A and B. The character “/” generally indicates an “or” relationship between the associated objects.

A term “indication” in this application may be a direct indication (or an explicit indication) or may be an indirect indication (or an implicit indication). The direct indication may be understood as that a sender explicitly notifies a receiver of content such as specific information, an operation that needs to be performed, or a request result in a sent indication. The indirect indication may be understood as that the receiver determines corresponding information according to an indication sent by the sender, or performs determination and determines an operation that needs to be performed or a request result according to a determination result.

It should be noted that the technology described in the embodiments of this application is not limited to a Long Term Evolution (LTE)/LTE-Advanced (LTE-A) system, and may be further applied to another wireless communication system such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), or another system. The terms “system” and “network” in the embodiments of this application are usually interchangeably used, and the technologies described may be applied to the systems and radio technologies mentioned above and may also be applied to other systems and radio technologies. The following description describes a New Radio (NR) system for an example purpose, and an NR term is used in most of the following description. However, those technologies may also be applied to an application other than an NR system application, such as a 6th Generation (6G) communication system.

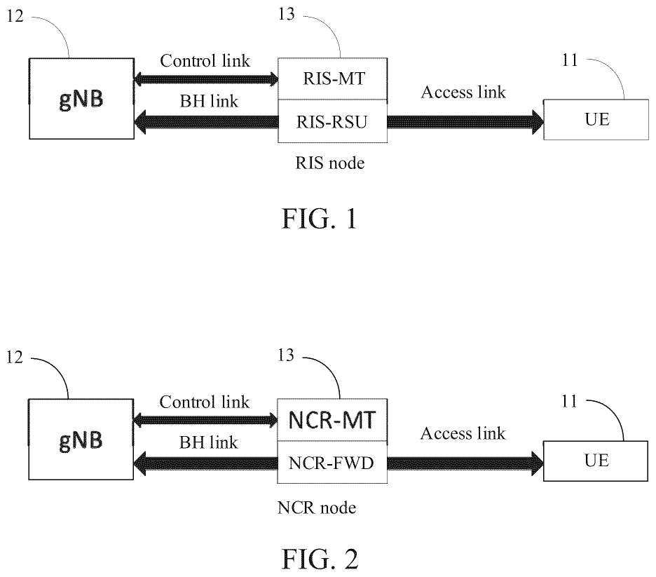

FIG. 1 or FIG. 2 is a block diagram of a wireless communication system to which an embodiment of this application is applicable. The wireless communication system includes a terminal 11, a network-side device 12, and a layer 1 forwarding node 13. The terminal 11 may be a mobile phone, a tablet computer (Tablet Personal Computer), a laptop computer, a notebook computer, a Personal Digital Assistant (PDA), a palmtop computer, a netbook, an Ultra-mobile Personal Computer (UMPC), a Mobile Internet Device (MID), an augmented reality (AR)/virtual reality (VR) device, a robot, a wearable device, a flight vehicle, a Vehicle User Equipment (VUE), a ship-borne equipment, a pedestrian terminal (Pedestrian User Equipment, PUE), a smart home appliance (a home equipment with a wireless communication function, such as a refrigerator, a TV, a washing machine, or a furniture), and a terminal-side device such as a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wrist strap, a smart dress, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in this embodiment of this application. The network-side device 12 may include an access network device or a core network device. The access network device may be referred to as a Radio Access Network (RAN) device, a radio access network function, or a radio access network unit. The access network device may include a base station, a Wireless Local Area Network (WLAN) Access Point (AP), a Wireless Fidelity (WiFi) node, and the like. The base station may be referred to as a Node B (NB), an Evolved Node B (eNB), the next generation node B (gNB), a New Radio Node B (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a home node B (HNB), a home evolved node B, a Transmission Reception Point (TRP), or any other suitable term in the art, as long as a same technical effect is achieved. The base station is not limited to a particular technical vocabulary. A layer 1 forwarding node 13 may be a forwarding node that forwards radio frequency signals between the network-side device 12 and the terminal 11 under control of the network-side device 12, such as a Reconfigurable Intelligent Surface (RIS) or a Network Controlled Repeater (NCR). It should be noted that this embodiment of this application is generally described by using an example in which the network-side device 12 is a base station in an NR system, the terminal 11 is a User Equipment (UE), and the layer 1 forwarding node 13 is an NCR node, and specific types of the network-side device, the terminal, and the layer 1 forwarding node are not limited.

For a RIS node, the RIS is implemented in different manners, and the RIS may be modeled as a RIS terminal module (RIS-Mobile Termination, RIS-MT) and a reflection surface unit (RIS-Reflection Surface Unit, RIS-RSU). FIG. 1 shows a logical structure of a RIS node. The RIS-MT is configured to establish a wireless connection between the RIS node and a serving base station, so as to send a measurement report of the RIS node to the base station and reflection control signaling for the RIS node from the base station. The RIS-RSU may be configured to reflect and transmit signals, including a synchronization signal/physical broadcast channel signal block (Synchronization Signal and PBCH block, SSB), a system message, uplink and downlink dedicated signaling, uplink and downlink control channels, uplink and downlink data signals, and the like, between the base station and the UE. The RIS-MT may use a separate antenna, or may share an antenna on the RIS-RSU. A RIS-RSU control unit (for example, a panel controller) is disposed between the RIS-MT and the RIS-RSU. The RIS-MT sends a received RIS-RSU control command to the RIS-RSU control unit, so that the RIS-RSU control unit controls the RIS-RSU. The base station may control transmit parameters of the RIS-RSU, including incident and reflected beam parameters, by sending signaling for controlling the RIS-RSU to the RIS-MT. The RIS-RSU unit of the RIS node may be a passive radio signal incident/reflection panel, and include a reflection array that includes several incident/reflection units. The base station may control a reflected beam of the RIS-RSU by configuring a phase-amplitude matrix of an incident/reflection array.

A reflection effect of the RIS-RSU brings about a plurality of impacts, as described in the following.
1. Valid reflection: Under control of the base station, a target signal is reflected in a direction of a target UE, so that a valid signal received by the target UE is strengthened.
2. Interference reflection 1: In a case that signals are not scheduled or reflected by the base station, all received signals are reflected in a direction in which a current reflection array points, causing interference.
3. Interference reflection 2: In a case that signals are scheduled or reflected by the base station, when all received target signals are reflected, generated sidelobes transmit the target signals in unintended directions, causing interference in the unintended directions.
4. Out-of-band reflection: The RIS-RSU may further reflect a band outside a target carrier bandwidth, causing interference.

For the NCR node,
the NCR node is configured to expand a coverage area of a cell, including receiving, amplifying, and forwarding a downlink signal from an upstream base station to increase strength of the signal that reaches the UE; and receiving, amplifying, and forwarding an uplink signal from the UE, so that strength of an uplink signal from the UE to the upstream base station increases.

The NCR node may accept control from the upstream base station, that is, the base station may control transmit parameters of the NCR node, such as ON/OFF and a transmit beam of the NCR node, so as to improve operational efficiency of the NCR node and reduce interference. A network structure shown in FIG. 2 includes 3 network nodes. An intermediate network node is an NCR node, including a Mobile Termination (MT) and a Repeater Unit (RU). The MT is also referred to as a terminal module, and the repeater unit is also referred to as an NCR forwarding (NCR-FWD) unit. It is not excluded that the NCR node includes only one of the MT or the RU. The MT may establish a connection to the upstream base station. The base station exchanges control signaling with the NCR node by using the MT, and may indicate transmission/reception-related parameters of the MT of the NCR node or indicate transmission- or reception-related parameters of the RU of the NCR node.

Similar to the RIS node, the NCR node is connected to the base station and controlled by the base station. That is, the base station sends control information to the NCR node by using the MT of the NCR node, and controls a Radio Frequency (RF) uplink and downlink power/amplification factor, a beam parameter, uplink and downlink configuration, and the like of the NCR node. Unlike the RIS node, an RF unit of the NCR node is an active signal amplifier, which may amplify and send a received signal.

In a related technology, after the NCR-MT enters a Radio Resource Control (RRC) inactive (INACTIVE) state, the NCR-FWD may continue forwarding according to a previously received forwarding configuration, with a main objective of saving wireless resources occupied by the NCR-MT and the gNB to maintain a wireless connection, so that more wireless resources can be used for forwarding However, after the NCR-MT is in the RRC_INACTIVE state, the base station cannot update the forwarding configuration of the NCR-FWD according to a requirement, and the NCR-MT cannot report state information to the base station either. As a result, forwarding performance of the NCR-FWD is degraded. For example, the target signal cannot be forwarded or cannot be completely forwarded, the target signal is forwarded to a non-target region, forwarding performance is degraded due to an NCR abnormality, and the like.

However, in this embodiment of this application, using the NCR node as an example, after the NCR-MT enters the RRC_INACTIVE state or an RRC idle (IDLE) state, if forwarding of the NCR-FWD is still in an enabled or partially enabled state, the NCR-MT may be triggered according to a condition to initiate a wireless connection establishment procedure, to restore the wireless connection between the NCR-MT and the base station in time. In this way, the base station may update a forwarding configuration of the NCR-FWD according to a requirement, and the NCR-MT may also report state information to the base station, thereby restoring forwarding performance of the NCR-FWD.

The radio link establishment method, the information transmission method, the radio link establishment apparatus, the information transmission apparatus, and the layer 1 forwarding node according to embodiments of this application are described in detail below by using some embodiments and application scenarios thereof with reference to the accompanying drawings.

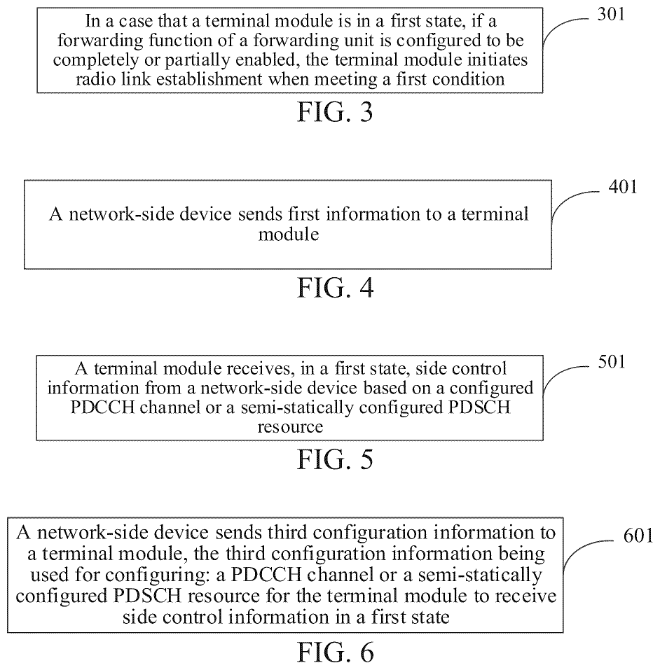

Referring to FIG. 3, the radio link establishment method according to an embodiment of this application may be performed by a terminal module in the layer 1 forwarding node. As shown in FIG. 3, the radio link establishment method provided in this embodiment of this application may include the following steps:

Step 301: In a case that a terminal module is in a first state, if a forwarding function of a forwarding unit is configured to be completely or partially enabled, the terminal module initiates radio link establishment when meeting a first condition, where the terminal module and the forwarding unit belong to a same layer 1 forwarding node, the first state includes a radio resource control RRC idle state or an RRC inactive state, and the meeting a first condition includes at least one of the following: the layer 1 forwarding node being abnormal, or a network-side device configuring or pre-configuring the terminal module to initiate radio link establishment.

For ease of description, in this embodiment of this application, an example in which the layer 1 forwarding node is an NCR node, the terminal module is an NCR-MT, and the forwarding unit is an NCR-FWD is used for description. Specific types of the layer 1 forwarding node, the terminal module, and the forwarding unit are not limited herein.

In an implementation, when a forwarding function of the NCR-FWD is configured to be enabled, the NCR-FWD may perform a forwarding behavior. In this case, if the NCR-MT is in the RRC idle state or an RRC inactive state, the NCR-MT cannot receive side control information or the forwarding configuration of the NCR-FWD from the network-side device, and the NCR-MT cannot report state information to the network-side device either. However, in this embodiment of this application, when the forwarding function of the NCR-FWD is configured to be enabled, if the NCR-MT is in the RRC idle state or the RRC inactive state, radio link establishment may be initiated when the first condition is met, to restore, establish, or reestablish the wireless connection between the NCR-MT and the network-side device. In this way, the NCR-MT may receive the side control information or the forwarding configuration of the NCR-FWD from the network-side device based on the wireless connection to the network-side device, and the NCR-MT also reports the state information to the network-side device.

In an implementation, the radio link establishment may include: RRC connection setup, RRC connection resume (RRC connection resumption), and RRC connection reestablishment.

In an implementation, the network-side device may configure a dedicated Physical Random Access Channel (PRACH) resource to initiate a non-contention access based wireless connection establishment procedure when the NCR-MT meets the first condition. In this case, the initiating, by the terminal module, radio link establishment when meeting a first condition includes:

initiating, by the terminal module when meeting the first condition, non-contention access-based wireless connection establishment based on a configured dedicated PRACH resource.

In an optional implementation, the layer 1 forwarding node being abnormal includes at least one of the following:
monitoring that signal strength of a first signal received by the terminal module is lower than or equal to a first preset threshold, the first signal being a broadcast signal from the network-side device; or
detecting a first event, where the first event indicates that the layer 1 forwarding node or the forwarding unit is in an abnormal state;
As an optional implementation, the a network-side device configuring or pre-configuring the terminal module to initiate radio link establishment includes at least one of the following:

the terminal module initiating a connection establishment procedure based on first pre-configuration information sent by the network-side device; or
the terminal module failing to receive side control information within a preset time duration, and the terminal module being configured, before entering the first state, with wireless channels or resources for receiving the side control information.

In an implementation, the foregoing first signal may be an SSB, a Channel State Information-Reference Signal (CSI-RS), or the like. When received signal strength of the first signal is lower than a pre-configured threshold, that is, a first preset threshold, it is determined that communication quality of a radio link of a Backhaul link (BH link) (referring to the BH link shown in FIG. 2) is poor and the BH link cannot provide an available backhaul link. In this case, the NCR-MT may trigger a cell search and selection procedure. After a suitable target cell supporting NCR access is determined, a radio link establishment procedure is initiated for the target cell.

In an implementation, the first event includes at least one of the following: the forwarding unit experiencing self-excitation;
a temperature of the forwarding unit exceeding a preset range, for example, an excessively high or excessively low temperature of the NCR-FWD; or
a hardware fault occurring in the layer 1 forwarding node, for example, a damaged transceiver antenna, a damaged ON-OFF component, or the like.

In this case, the meeting a first condition may include: the NCR-MT may initiate wireless connection establishment in the first state in a case that the NCR node is abnormal.

In some embodiments, after completing the wireless connection establishment, the NCR-MT may report abnormal information of the first event to the network-side device.

For example, the method further includes:
sending, by the terminal module, first indication information to the network-side device in a case that the RRC connected state is entered based on the radio link establishment, the first indication information indicating abnormality information triggering the terminal module to enter the first state.

The first indication information may indicate at least one of the following:
identifier information of the layer 1 forwarding node, type information of an abnormality, or occurrence time information of the abnormality.

In an implementation, the UE may report an abnormality, which triggers the radio link establishment, by using a Medium Access Control Control Element (MAC CE) or RRC message.

In an implementation, before the NCR-MT enters the first state, that is, when the NCR-MT is in the RRC connected state, the network-side device may pre-configure a wireless connection establishment procedure after the NCR-MT enters the first state. For example, after entering the first state, the NCR-MT initiates the wireless connection establishment procedure at a predetermined time interval.

As an implementation, the first pre-configuration information is used for configuring at least one of the following:
initiation of wireless connection establishment at a first moment, the first moment being spaced apart, by a first preset duration, from a moment at which the terminal module enters the first state or a moment at which the terminal module last receives the side control information before entering the first state; or
the terminal module to send periodic heartbeat information.

In an implementation, in a case that the first pre-configuration information is used for configuring initiation of wireless connection establishment at the first moment and the terminal module is in the first state, if the forwarding function of the forwarding unit is configured to be completely or partially enabled, the initiating, by the terminal module, radio link establishment when meeting a first condition includes:
starting, by the terminal module, a first timer when being released to the first state by a target network-side device, where a timing duration of the first timer is the first preset duration; and
initiating, by the terminal module, a radio link establishment procedure to the target network-side device when the first timer expires.

For example, the NCR-MT may start a timer when released by the target cell to the first state. A timing duration of the timer is the first preset duration. In this way, when the timer expires, the NCR-MT initiates the radio link establishment procedure to the target cell according to the first pre-configuration information.

In some embodiments, the method further includes:
stopping or deactivating, by the terminal module, the first timer when initiating the radio link establishment or completing the radio link establishment.

In this way, by stopping the first timer when initiating or completing the radio link establishment, the NCR-MT can avoid that the first timer expires and the NCR-MT are repeatedly triggered to initiate the radio link establishment.

In an implementation, when the first pre-configuration information is used for configuring the terminal module to send the periodic heartbeat information, the NCR-MT periodically sends the heartbeat information to the network-side device at an interval. In this way, if the NCR-MT is in the first state when the NCR-MT sends the heartbeat information to the network-side device, the NCR-MT may initiate the radio link establishment.

In some embodiments, the terminal module fails to receive side control information within a preset time duration, and the terminal module is configured, before entering the first state, with wireless channels or resources for receiving the side control information.

In an implementation, the network-side device may configure wireless channels or resources used by the NCR-MT to receive the side control information in the RRC connected state. In this way, during a period in which the NCR-MT is in the first state, the side control information from the network-side device cannot be received, and the radio link establishment is initiated accordingly.

For example, before releasing the NCR-MT to the RRC_INACTIVE/RRC_IDLE state, the base station configures wireless channels and resources, for example, a paging channel, for the NCR-MT to receive the side control information. However, after entering the RRC_INACTIVE/RRC_IDLE, the NCR-MT cannot receive the side control information. In this way, the NCR-MT may initiate the radio link establishment procedure based on that the NCR-MT fails to receive the side control information within a preset time duration.

The side control information is used for controlling a forwarding behavior of the NCR-FWD. For example, the side control information is used for controlling an uplink beam and a downlink beam of the NCR-FWD during forwarding and controlling the NCR-FWD to enable or disable forwarding, and the like.

As an optional implementation, the method further includes:
performing, by the terminal module, a first operation when determining to initiate radio link establishment, the first operation including at least one of the following:
controlling the forwarding unit to cease a forwarding behavior;
ceasing, by the forwarding unit, an uplink forwarding behavior or a downlink forwarding behavior when sending a signal to the network-side device; or
ceasing, by the forwarding unit, an uplink forwarding behavior or a downlink forwarding behavior when receiving a transmission signal from the network-side device.

In an implementation, the NCR-MT may share a transmit radio frequency unit and a receive radio frequency unit with the NCR-FWD. In this case, when it is determined that the NCR-MT initiates the radio link establishment, the NCR-FWD may be enabled to cease a forwarding behavior, so that the radio frequency unit is configured for signaling interaction of the NCR-MT during establishment of a radio link, thereby achieving beneficial effects such as improving reliability of the radio link establishment procedure and reducing a delay of the radio link establishment procedure.

In an implementation, the NCR-MT may share the transmit radio frequency unit with the NCR-FWD. In this case, when the NCR-MT sends a signal to the network-side device, by ceasing an uplink forwarding behavior or a downlink forwarding behavior of the NCR-FWD, the transmit radio frequency unit may be configured for signaling interaction of the NCR-MT during establishment of the radio link, thereby achieving beneficial effects such as improving reliability of the radio link establishment procedure and reducing a delay of the radio link establishment procedure.

In an implementation, the NCR-MT may share the receive radio frequency unit with the NCR-FWD. In this case, when the NCR-MT receives a transmission signal from the network-side device, by ceasing the uplink forwarding behavior or the downlink forwarding behavior of the NCR-FWD, the receive radio frequency unit may be configured for signaling interaction of the NCR-MT during establishment of the radio link, thereby achieving beneficial effects such as improving reliability of the radio link establishment procedure and reducing a delay of the radio link establishment procedure.

In this embodiment of this application, in a case that a terminal module is in a first state, if a forwarding function of a forwarding unit is configured to be completely or partially enabled, the terminal module initiates radio link establishment when meeting a first condition, where the terminal module and the forwarding unit belong to a same layer 1 forwarding node, the first state includes a radio resource control RRC idle state or an RRC inactive state, and the meeting a first condition includes at least one of the following: the layer 1 forwarding node being abnormal, or a network-side device configuring or pre-configuring the terminal module to initiate radio link establishment. When an NCR-MT enters an RRC inactive or idle state and an NCR-FWD performs a forwarding behavior, by initiating a radio link establishment procedure, the NCR-MT can restore an RRC connected state in time. In this way, in the connected state, the NCR-MT can report state information thereof to a base station, receive a forwarding configuration from the base station, and the like, which can improve performance of forwarding a target signal by the NCR-FWD.

Referring to FIG. 4, an embodiment of this application further provides a forwarding configuration method. The method may be performed by a network-side device. As shown in FIG. 4, the forwarding configuration method provided in this embodiment of this application may include the following steps:

Step 401: A network-side device sends first information to a terminal module, the first information including at least one of the following:
first pre-configuration information, the first pre-configuration information being used for pre-configuring initiation of a radio link establishment procedure in a case that the terminal module is in a first state and a forwarding function of a forwarding unit is configured to be completely or partially enabled, where the terminal module and the forwarding unit belong to a same layer 1 forwarding node, and the first state includes a radio resource control RRC idle state or an RRC inactive state; or
second configuration information, the second configuration information being configured by the network-side device before the terminal module enters the first state, and the second configuration information being used for configuring wireless channels or resources for receiving the side control information when the terminal module is in the first state.

The forwarding configuration method provided in this embodiment of this application is used for configuring the terminal module to perform the radio link establishment method shown in FIG. 3. For explanations of terms such as the layer 1 forwarding node, the terminal module, the forwarding unit, the radio link establishment procedure, the first state, and the side control information in this embodiment of this application, refer to the explanations in the method embodiment shown in FIG. 3. Details are not described herein again.

As an optional implementation, the first pre-configuration information is used for configuring at least one of the following:
initiation of wireless connection establishment at a first moment, the first moment being spaced apart, by a first preset duration, from a moment at which the terminal module enters the first state or a moment at which the terminal module last receives the side control information before entering the first state; or the terminal module to send periodic heartbeat information.

As an optional implementation, the method further includes:
receiving, by the network-side device, first indication information from the terminal module in a case that an RRC connected state between the network-side device and the terminal module is restored, where the first indication information indicates abnormality information triggering the terminal module to enter the first state.

As an optional implementation, the first indication information indicates at least one of the following:
identifier information of the layer 1 forwarding node, type information of an abnormality, or occurrence time information of the abnormality.

The forwarding configuration method provided in this embodiment of this application is used for configuring the terminal module to perform the radio link establishment method shown in FIG. 3, and can achieve a same beneficial effect as the method embodiment shown in FIG. 3. To avoid repetition, details are not described herein again.

Referring to FIG. 5, an embodiment of this application further provides an information transmission method. The method may be performed by a terminal module of a layer 1 forwarding node. As shown in FIG. 5, the information transmission method provided in this embodiment of this application may include the following steps:

Step 501: A terminal module receives, in a first state, side control information from a network-side device based on a configured PDCCH channel or a semi-statically configured PDSCH resource, where the first state includes a radio resource control RRC idle state or an RRC inactive state, the side control information is used for controlling a forwarding behavior of a forwarding unit, and the terminal module and the forwarding unit are located on a same layer 1 forwarding node.

For ease of description, in this embodiment of this application, an example in which the layer 1 forwarding node is an NCR node, the terminal module is an NCR-MT, and the forwarding unit is an NCR-FWD is used for description. Specific types of the layer 1 forwarding node, the terminal module, and the forwarding unit are not limited herein.

The terminal module receives, in the first state, the side control information from the network-side device based on the configured PDCCH channel or the semi-statically configured PDSCH resource. That is, in the RRC connected state, the NCR-MT is configured with PDCCH channels or semi-statically configured PDSCH resources available in the RRC inactive state or RRC idle state. In this way, the NCR-MT may receive the side control information from the network-side device in the RRC inactive state or the RRC idle state based on the PDCCH channel or the semi-statically configured PDSCH resource.

In an implementation, the side control information is used for controlling a forwarding behavior of the NCR-FWD. For example, the side control information includes: beam information for uplink/downlink forwarding or forwarding on/off information.

In some embodiments, the forwarding on/off information may instruct the forwarding unit to perform at least one of the following:
enabling or disabling uplink forwarding;
enabling or disabling downlink forwarding; or
enabling or disabling a forwarding behavior.

In some embodiments, the beam information for forwarding may implicitly instruct the forwarding unit to perform at least one of the following:
enabling or disabling uplink forwarding;
enabling or disabling downlink forwarding; or
enabling or disabling a forwarding behavior.

In an implementation, the beam information may be a beam identifier or a transmission direction, for example, an uplink beam or a downlink beam. For example, in a case that the beam information for forwarding includes an uplink beam, uplink forwarding may be enabled.

In this implementation, the beam information or the forwarding on/off information is received in the first state, to implicitly indicate a forwarding on/off behavior of the NCR-FWD by using the beam information or explicitly indicate the forwarding on/off behavior of the NCR-FWD by using the forwarding on/off information.

As an optional implementation, a first message carries first configuration information, the first message is used for releasing the terminal module to the first state, and the first configuration information is used for configuring the terminal module to receive the side control information from the network-side device in the first state.

The first message may also be referred to as a release message, and is used for releasing the NCR-MT to the RRC idle state or the RRC inactive state.

For example, the base station may configure, in a message of releasing the NCR-MT to the RRC_INACTIVE or RRC_IDLE state, the NCR-MT to continue receiving the side control information from the base station after the NCR-MT enters the RRC_INACTIVE or RRC_IDLE state. Then, the base station may send the side control information to the NCR-MT in the RRC_INACTIVE or RRC_IDLE state by using a paging message.

In this embodiment of this application, in the first state, the terminal module may still receive the side control information from the network-side device based on the configured PDCCH channel or the semi-statically configured PDSCH resource, and the forwarding behavior of the forwarding unit may be controlled based on the side control information. In this way, the terminal module can also receive the side control information even in the RRC inactive state or the RRC idle state, so that the forwarding unit adjusts a forwarding configuration according to the side control information, which can improve forwarding performance of the forwarding unit.

The radio link establishment method provided in the embodiments of this application may be performed by a radio link establishment apparatus. In the embodiments of this application, the radio link establishment apparatus provided in an embodiment of this application is described with an example in which the radio link establishment apparatus performs the radio link establishment method.

Referring to FIG. 6, an embodiment of this application further provides a resource configuration method. The method may be performed by a network-side device. As shown in FIG. 6, the resource configuration method provided in this embodiment of this application may include the following steps:

Step 601: A network-side device sends third configuration information to a terminal module, the third configuration information being used for configuring: a PDCCH channel or a semi-statically configured PDSCH resource for the terminal module to receive side control information in a first state, where the first state includes a radio resource control RRC idle state or an RRC inactive state, the side control information is used for controlling a forwarding behavior of a forwarding unit, and the terminal module and the forwarding unit are located on a same layer 1 forwarding node.

The resource configuration method provided in this embodiment of this application is used for configuring resources used by the terminal module to perform the information transmission method shown in FIG. 5. For explanations of terms such as the layer 1 forwarding node, the terminal module, the forwarding unit, the PDCCH channel or the semi-statically configured PDSCH resource, the first state, and the side control information in this embodiment of this application, refer to the explanations in the method embodiment shown in FIG. 5. Details are not described herein again.

As an optional implementation, the method further includes:
sending, by the network-side device in a case that the terminal module is in the first state, the side control information to the terminal module based on the PDCCH channel or the PDSCH resource configured by the third configuration information.

As an optional implementation, the method further includes:
sending, by the network-side device, a first message to the terminal module, where the first message is used for releasing the terminal module to the first state, and the first message carries first configuration information, the first configuration information being used for configuring the terminal module to receive the side control information from the network-side device in the first state.

The resource configuration method provided in this embodiment of this application is used for configuring resources used by the terminal module to perform the information transmission method shown in FIG. 5, and can achieve a same beneficial effect as the method embodiment shown in FIG. 5. To avoid repetition, details are not described herein again.

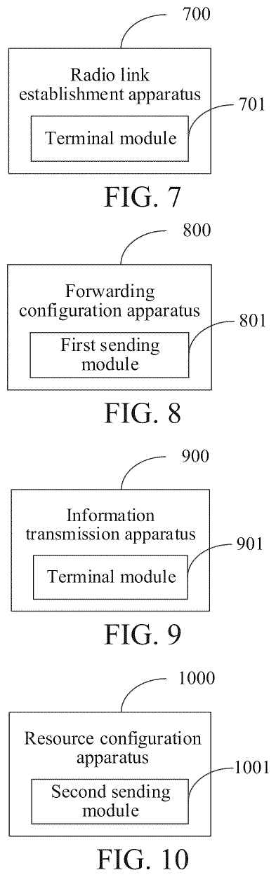

Referring to FIG. 7, a radio link establishment apparatus provided in this application may be an apparatus in a terminal module, and the terminal module belongs to a layer 1 forwarding node. As shown in FIG. 7, the radio link establishment apparatus 700 may include the following modules:
a terminal module 701, configured to initiate, in a first state, radio link establishment when meeting a first condition if a forwarding function of a forwarding unit is configured to be completely or partially enabled, where the terminal module and the forwarding unit belong to a same layer 1 forwarding node, the first state includes a radio resource control RRC idle state or an RRC inactive state, and the meeting a first condition includes at least one of the following: the layer 1 forwarding node being abnormal, or a network-side device configuring or pre-configuring the terminal module to initiate radio link establishment.

In some embodiments, the layer 1 forwarding node being abnormal includes at least one of the following:
monitoring that signal strength of a first signal received by the terminal module 701 is lower than or equal to a first preset threshold, the first signal being a broadcast signal from the network-side device; or
detecting a first event, where the first event indicates that the layer 1 forwarding node or the forwarding unit is in an abnormal state.

The a network-side device configuring or pre-configuring the terminal module to initiate radio link establishment includes at least one of the following:
the terminal module 701 initiating a connection establishment procedure based on first pre-configuration information sent by the network-side device; or
the terminal module 701 failing to receive side control information within a preset time duration, and the terminal module 701 being configured, before entering the first state, with wireless channels or resources for receiving the side control information.

In some embodiments, the first event includes at least one of the following:
the forwarding unit experiencing self-excitation;
a temperature of the forwarding unit exceeding a preset range; or
a hardware fault occurring in the layer 1 forwarding node.

In some embodiments, the first pre-configuration information is used for configuring at least one of the following:
initiation of wireless connection establishment at a first moment, the first moment being spaced apart, by a first preset duration, from a moment at which the terminal module 701 enters the first state or a moment at which the terminal module last receives the side control information before entering the first state; or
the terminal module 701 to send periodic heartbeat information.

In some embodiments, in a case that the first pre-configuration information is used for configuring initiation of wireless connection establishment at a first moment and the terminal module 701 is in the first state, if the forwarding function of the forwarding unit is configured to be completely or partially enabled, the initiating, by the terminal module 701 when meeting a first condition, radio link establishment includes:
starting, by the terminal module 701, a first timer when being released to the first state by a target network-side device, where a timing duration of the first timer is the first preset duration; and
initiating, by the terminal module 701, a radio link establishment procedure to the target network-side device when the first timer expires.

In some embodiments, the terminal module 701 is further configured to:
stop or deactivate the first timer when initiating the radio link establishment or completing the radio link establishment.

In some embodiments, the terminal module 701 is configured to:
initiate, when the first condition is met, non-contention access-based wireless connection establishment based on a configured dedicated physical random access channel PRACH resource.

In some embodiments, the terminal module 701 is further configured to:
perform a first operation when determining to initiate radio link establishment, the first operation including at least one of the following:
controlling the forwarding unit to cease a forwarding behavior;
ceasing, by the forwarding unit, an uplink forwarding behavior or a downlink forwarding behavior when sending a signal to the network-side device; or
ceasing, by the forwarding unit, an uplink forwarding behavior or a downlink forwarding behavior when receiving a transmission signal from the network-side device.

In some embodiments, the terminal module 701 is further configured to:
send first indication information to the network-side device in a case that the RRC connected state is entered based on the radio link establishment, the first indication information indicating abnormality information triggering the terminal module 701 to enter the first state.

In some embodiments, the first indication information indicates at least one of the following:
identifier information of the layer 1 forwarding node, type information of an abnormality, or occurrence time information of the abnormality.

The radio link establishment apparatus 700 in this embodiment of this application may be an electronic device, for example, an electronic device having an operating system, or may be a component in the electronic device, for example, an integrated circuit or a chip. The electronic device may be a layer 1 forwarding node. Exemplarily, the layer 1 forwarding node may include, but is not limited to, the type of the layer 1 forwarding node 13 listed above, which is not specifically limited in this embodiment of this application.

The radio link establishment apparatus 700 provided in this embodiment of this application can implement various processes of the method embodiment in FIG. 3, and achieve a same technical effect. To avoid repetition, details are not described herein again.

The forwarding configuration method provided in the embodiments of this application may be performed by a resource configuration apparatus. In the embodiments of this application, the forwarding configuration apparatus provided in an embodiment of this application is described with an example in which the forwarding configuration apparatus performs the forwarding configuration method.

Referring to FIG. 8, the forwarding configuration apparatus provided in this application may be an apparatus in a network-side device. As shown in FIG. 8, the forwarding configuration apparatus 800 may include the following modules:
a first sending module 801, configured to send first information to a terminal module, the first information including at least one of the following:
first pre-configuration information, the first pre-configuration information being used for pre-configuring initiation of a radio link establishment procedure in a case that the terminal module is in a first state and a forwarding function of a forwarding unit is configured to be completely or partially enabled, where the terminal module and the forwarding unit belong to a same layer 1 forwarding node, and the first state includes a radio resource control RRC idle state or an RRC inactive state; and
second configuration information, the second configuration information being wireless channels or resources that are configured by the network-side device before the terminal module enters the first state and are used for transmitting the side control information.

In some embodiments, the first pre-configuration information is used for configuring at least one of the following:
initiation of wireless connection establishment at a first moment, the first moment being spaced apart, by a first preset duration, from a moment at which the terminal module enters the first state or a moment at which the terminal module last receives the side control information before entering the first state; and the terminal module to send periodic heartbeat information.

In some embodiments, the forwarding configuration apparatus 800 further includes:
a receiving module, configured to receive, by the network-side device, first indication information from the terminal module in a case that an RRC connected state between the network-side device and the terminal module is restored, where the first indication information indicates abnormality information triggering the terminal module to enter the first state.

In some embodiments, the first indication information indicates at least one of the following:
identifier information of the layer 1 forwarding node, type information of an abnormality, and occurrence time information of the abnormality.

The forwarding configuration apparatus 800 provided in this embodiment of this application can implement various processes of the method embodiment in FIG. 4, and achieve a same technical effect. To avoid repetition, details are not described herein again.

The information transmission method provided in the embodiments of this application may be performed by an information transmission apparatus. In the embodiments of this application, the information transmission apparatus provided in an embodiment of this application is described with an example in which the information transmission apparatus performs the information transmission method.

Referring to FIG. 9, the information transmission apparatus provided in this application may be an apparatus in a terminal module, and the terminal module belongs to a layer 1 forwarding node. As shown in FIG. 9, the information transmission apparatus 900 may include the following modules:
a terminal module 901, configured to receive, in a first state, side control information from a network-side device based on a configured PDCCH channel or a semi-statically configured PDSCH resource, where the first state includes a radio resource control RRC idle state or an RRC inactive state, the side control information is used for controlling a forwarding behavior of a forwarding unit, and the terminal module and the forwarding unit are located on a same layer 1 forwarding node.

In some embodiments, a first message carries first configuration information, the first message is used for releasing the terminal module to the first state, and the first configuration information is used for configuring the terminal module to receive the side control information from the network-side device in the first state.

In some embodiments, the side control information includes: beam information for uplink/downlink forwarding or forwarding on/off information.

In this embodiment of this application, the information transmission apparatus 900 may be an electronic device, such as an electronic device having an operating system, or a component within an electronic device, such as an integrated circuit or a chip. The electronic device may be a layer 1 forwarding node. Exemplarily, the layer 1 forwarding node may include, but not limited to, the type of the layer 1 forwarding node 13 listed above, which is not specifically limited in this embodiment of this application.

The information transmission apparatus 900 provided in this embodiment of this application can implement various processes implemented in the method embodiment illustrated in FIG. 5 and achieve a same technical effect. To avoid repetition, details are not described herein again.

The resource configuration method provided in the embodiments of this application may be performed by a resource configuration apparatus. In the embodiments of this application, a resource configuration apparatus provided in an embodiment of this application is described with an example in which the resource configuration apparatus performs the resource configuration method.

Referring to FIG. 10, the resource configuration apparatus provided in this application may be an apparatus in a network-side device. As shown in FIG. 10, the resource configuration apparatus 1000 may include the following modules:
a second sending module 1001, configured to send third configuration information to a terminal module, the third configuration information being used for configuring: a PDCCH channel or a semi-statically configured PDSCH resource for the terminal module to receive side control information in a first state, where the first state includes a radio resource control RRC idle state or an RRC inactive state, the side control information is used for controlling a forwarding behavior of a forwarding unit, and the terminal module and the forwarding unit are located on a same layer 1 forwarding node.

In some embodiments, the resource configuration apparatus 1000 further includes:
a third sending module, configured to send, by the network-side device in a case that the terminal module is in the first state, the side control information to the terminal module based on the PDCCH channel or the PDSCH resource configured by the third configuration information.

In some embodiments, the resource configuration apparatus 1000 further includes:
a fourth sending module, configured to send a first message to the terminal module, where the first message is used for releasing the terminal module to the first state, and the first message carries first configuration information, the first configuration information being used for configuring the terminal module to receive the side control information from the network-side device in the first state.

The resource configuration apparatus 1000 provided in this embodiment of this application can implement various processes of the method embodiment in FIG. 6, and achieve a same technical effect. To avoid repetition, details are not described herein again.

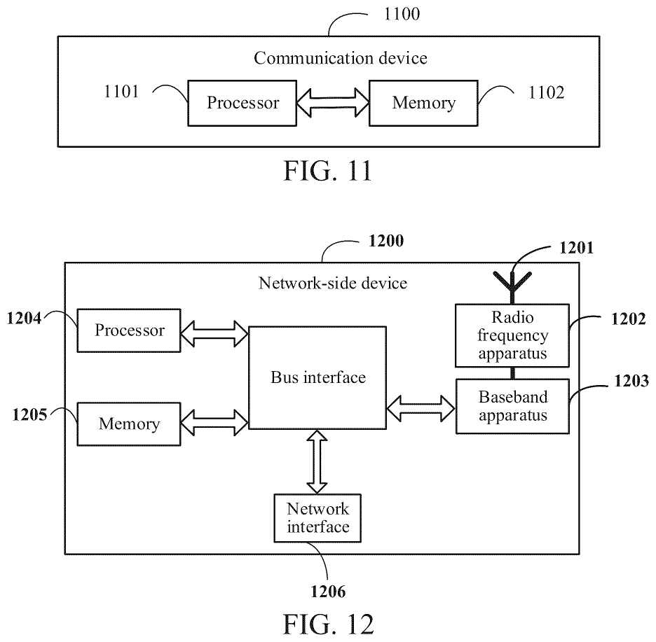

As shown in FIG. 11, an embodiment of this application further provides a communication device 1100, including a processor 1101 and a memory 1102. The memory 1102 stores a program or an instruction executable on the processor 1101. In a case that the communication device 1100 is a layer 1 forwarding node, when the program or the instruction is executed by the processor 1101, the steps of the radio link establishment method embodiment or the information transmission method embodiment are implemented. In a case that the communication device 1100 is a network-side device, when the program or the instruction is executed by the processor 1101, the steps of the forwarding configuration method embodiment or the resource configuration method embodiment are implemented, and a same technical effect can be achieved. To avoid repetition, details are not described herein again.

An embodiment of this application further provides a network-side device. As shown in FIG. 12, the network-side device 1200 includes: an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information by using the antenna 1201, and sends the received information to the baseband apparatus 1203 for processing. In a downlink direction, the baseband apparatus 1203 processes information to be sent and sends the information to the radio frequency apparatus 1202. The received information is processed by the radio frequency apparatus 1202 and is then sent by using the antenna 1201.

The method performed by the network-side device in the above embodiments may be implemented in the baseband apparatus 1203. The baseband apparatus 1203 includes a baseband processor. The baseband apparatus 1203 may include, for example, at least one baseband board. A plurality of chips are disposed on the baseband board. As shown in FIG. 12, one chip is, for example, the baseband processor, and is connected to the memory 1205 by using a bus interface, to call a program in the memory 1205 to perform the operations of the network device shown in the foregoing method embodiments.

The network-side device may further include a network interface 1206, and the interface is, for example, a Common Public Radio Interface (CPRI).

The network-side device 1200 in this embodiment of the present application further provides: an instruction or a program stored in the memory 1205 and executable on the processor 1204. The processor 1204 calls the instruction or the program in the memory 1205 to execute the method performed by each module in FIG. 8 or FIG. 10, and achieves a same technical effect. To avoid repetition, details are not described herein again.

An embodiment of this application further provides a readable storage medium. A program or an instruction is stored in the readable storage medium. When the program or the instruction is executed by a processor, the processes of any method embodiment in FIG. 3 to FIG. 6 are implemented, and a same technical effect can be achieved. To avoid repetition, details are not described herein again.

The processor is the processor in the layer 1 forwarding node or the network-side device described in the foregoing embodiments. The readable storage medium includes a computer-readable storage medium, for example, a computer read-only memory ROM, a random access memory RAM, a magnetic disk, an optical disk, and the like. In some examples, the readable storage medium may be a non-transient readable storage medium.

An embodiment of this application also provides a chip. The chip includes a processor and a communication interface. The communication interface is coupled to the processor, the processor is configured to run a program or an instruction, to implement the processes of any method embodiment shown in FIG. 3 to FIG. 6, and a same technical effect can be achieved. To avoid repetition, details are not described herein again.

It will be appreciated that the chip mentioned in this embodiment of this application may also be referred to as a system on chip, a system chip, a system on a chip or a system-on-a-chip, or the like.

An embodiment of this application also provides a computer program/program product. The computer program/program product is stored in a storage medium, the computer program/program product is executed by at least one processor to implement the processes of any method embodiment shown in FIG. 3 to FIG. 6, and a same technical effect can be achieved. To avoid repetition, details are not described herein again.

It should be noted that the terms “include”, “comprise”, or any other variations thereof in this specification are intended to cover a non-exclusive inclusion, such that a process, method, article, or apparatus including a series of elements not only includes those elements, but also includes other elements that are not explicitly listed, or also includes elements inherent to such a process, method, article, or apparatus. Without more restrictions, the elements defined by the sentence “including/comprising a/an . . . ” do not exclude existence of other identical elements in the process, the method, the article, or the apparatus including the elements. Moreover, it should be noted that the scope of the method and the apparatus in the implementations of this application is not limited to performing functions in the order shown or discussed, but may include performing functions in a substantially concurrent manner or in reverse order depending on the functionality involved, for example, the method described may be performed in an order different from that described, and various steps may also be added, omitted, or combined. Moreover, features described with reference to some examples may be combined in other examples.

According to the descriptions in the foregoing implementations, a person skilled in the art may clearly learn that the method according to the foregoing embodiments may be implemented by a computer software product plus a general-purpose hardware platform, or by hardware. The computer software product is stored in a storage medium (such as a ROM, a RAM, a magnetic disk, or an optical disk), including several instructions to enable a terminal or a network-side device to perform the methods in the embodiments of this application.

The embodiments of this application are described above with reference to the accompanying drawings. However, this application is not limited to the specific implementations described above. The specific implementations described above are merely illustrative and not restrictive. Those of ordinary skill in the art may make various forms under the teaching of this application without departing from the spirit of this application and the protection scope of the claims, and these implementations shall all fall within the protection of this application.

What is claimed is:

1. A radio link establishment method, comprising:
when a terminal module is in a first state, in response to a forwarding function of a forwarding unit being configured to be completely or partially enabled, initiating, by the terminal module, radio link establishment when meeting a first condition, wherein the terminal module and the forwarding unit belong to a same layer 1 forwarding node, the first state comprises a radio resource control (RRC) idle state or an RRC inactive state, and the meeting a first condition comprises at least one of the following: the layer 1 forwarding node being abnormal, or a network-side device configuring or pre-configuring the terminal module to initiate radio link establishment.

2. The method according to claim 1, wherein
the layer 1 forwarding node being abnormal comprises at least one of the following:
monitoring that signal strength of a first signal received by the terminal module is lower than or equal to a first preset threshold, the first signal being a broadcast signal from the network-side device; or
detecting a first event, wherein the first event indicates that the layer 1 forwarding node or the forwarding unit is in an abnormal state; or
the network-side device configuring or pre-configuring the terminal module to initiate radio link establishment comprises at least one of the following:
the terminal module initiating a connection establishment procedure based on first pre-configuration information sent by the network-side device; or
the terminal module failing to receive side control information within a preset time duration, and the terminal module being configured, before entering the first state, with wireless channels or resources for receiving the side control information.

3. The method according to claim 2, wherein the first event comprises at least one of the following:
the forwarding unit experiencing self-excitation;
a temperature of the forwarding unit exceeding a preset range; or
a hardware fault occurring in the layer 1 forwarding node.

4. The method according to claim 2, wherein the first pre-configuration information is used for configuring at least one of the following:
initiation of wireless connection establishment at a first moment, the first moment being spaced apart, by a first preset duration, from a moment at which the terminal module enters the first state or a moment at which the terminal module last receives the side control information before entering the first state; or
the terminal module to send periodic heartbeat information.

5. The method according to claim 4, wherein when the first pre-configuration information is used for configuring initiation of the wireless connection establishment at the first moment and the terminal module is in the first state, in response to the forwarding function of the forwarding unit being configured to be completely or partially enabled, the initiating, by the terminal module, radio link establishment when meeting a first condition comprises:
starting, by the terminal module, a first timer when being released to the first state by a target network-side device, wherein a timing duration of the first timer is the first preset duration; and
initiating, by the terminal module, a radio link establishment procedure to the target network-side device when the first timer expires.

6. The method according to claim 5, further comprising:
stopping or deactivating, by the terminal module, the first timer when initiating the radio link establishment or completing the radio link establishment.

7. The method according to claim 1, wherein the initiating, by the terminal module, radio link establishment when meeting a first condition comprises:
initiating, by the terminal module when meeting the first condition, non-contention access-based wireless connection establishment based on a configured dedicated physical random access channel (PRACH) resource.

8. The method according to claim 1, further comprising:
performing, by the terminal module, a first operation when determining to initiate radio link establishment, the first operation comprising at least one of the following:
controlling the forwarding unit to cease a forwarding behavior;
ceasing, by the forwarding unit, an uplink forwarding behavior or a downlink forwarding behavior when sending a signal to the network-side device; or
ceasing, by the forwarding unit, an uplink forwarding behavior or a downlink forwarding behavior when receiving a transmission signal from the network-side device.

9. The method according to claim 1, further comprising:
sending, by the terminal module, first indication information to the network-side device when an RRC connected state is entered based on the radio link establishment, the first indication information indicating abnormality information triggering the terminal module to enter the first state.

10. The method according to claim 9, wherein the first indication information indicates at least one of the following:
identifier information of the layer 1 forwarding node, type information of an abnormality, or occurrence time information of the abnormality.

11. A forwarding configuration method, comprising:
sending, by a network-side device, first information to a terminal module, the first information comprising at least one of the following:
first pre-configuration information, the first pre-configuration information being used for pre-configuring initiation of a radio link establishment procedure when the terminal module is in a first state and a forwarding function of a forwarding unit is configured to be completely or partially enabled, wherein the terminal module and the forwarding unit belong to a same layer 1 forwarding node, and the first state comprises a radio resource control (RRC) idle state or an RRC inactive state; or
second configuration information, the second configuration information being configured by the network-side device before the terminal module enters the first state, and the second configuration information being used for configuring wireless channels or resources for receiving side control information when the terminal module is in the first state.

12. The method according to claim 11, wherein the first pre-configuration information is used for configuring at least one of the following:
initiation of wireless connection establishment at a first moment, the first moment being spaced apart, by a first preset duration, from a moment at which the terminal module enters the first state or a moment at which the terminal module last receives the side control information before entering the first state; or
the terminal module to send periodic heartbeat information.

13. The method according to claim 12, further comprising:
receiving, by the network-side device, first indication information from the terminal module when an RRC connected state between the network-side device and the terminal module is restored, wherein the first indication information indicates abnormality information triggering the terminal module to enter the first state.

14. The method according to claim 13, wherein the first indication information indicates at least one of the following:
identifier information of the layer 1 forwarding node, type information of an abnormality, or occurrence time information of the abnormality.

15. A layer 1 forwarding node, comprising: a memory storing a computer program; and a processor coupled to the memory and configured to execute the computer program to perform operations comprising:
when a terminal module is in a first state, in response to a forwarding function of a forwarding unit being configured to be completely or partially enabled, initiating, by the terminal module, radio link establishment when meeting a first condition, wherein the terminal module and the forwarding unit belong to the layer 1 forwarding node, the first state comprises a radio resource control (RRC) idle state or an RRC inactive state, and the meeting a first condition comprises at least one of the following: the layer 1 forwarding node being abnormal, or a network-side device configuring or pre-configuring the terminal module to initiate radio link establishment.

16. The layer 1 forwarding node according to claim 15, wherein
the layer 1 forwarding node being abnormal comprises at least one of the following:
monitoring that signal strength of a first signal received by the terminal module is lower than or equal to a first preset threshold, the first signal being a broadcast signal from the network-side device; or
detecting a first event, wherein the first event indicates that the layer 1 forwarding node or the forwarding unit is in an abnormal state; or
the network-side device configuring or pre-configuring the terminal module to initiate radio link establishment comprises at least one of the following:
the terminal module initiating a connection establishment procedure based on first pre-configuration information sent by the network-side device; or
the terminal module failing to receive side control information within a preset time duration, and the terminal module being configured, before entering the first state, with wireless channels or resources for receiving the side control information.

17. The layer 1 forwarding node according to claim 15, wherein the operations further comprises:
performing, by the terminal module, a first operation when determining to initiate radio link establishment, the first operation comprising at least one of the following:
controlling the forwarding unit to cease a forwarding behavior;
ceasing, by the forwarding unit, an uplink forwarding behavior or a downlink forwarding behavior when sending a signal to the network-side device; or
ceasing, by the forwarding unit, an uplink forwarding behavior or a downlink forwarding behavior when receiving a transmission signal from the network-side device.

18. A non-transitory computer-readable storage medium, storing a computer program, wherein the computer program, when executed by a processor, causes the processor to perform the radio link establishment method according to claim 1.

19. The non-transitory computer-readable storage medium according to claim 18, wherein
the layer 1 forwarding node being abnormal comprises at least one of the following:
monitoring that signal strength of a first signal received by the terminal module is lower than or equal to a first preset threshold, the first signal being a broadcast signal from the network-side device; or
detecting a first event, wherein the first event indicates that the layer 1 forwarding node or the forwarding unit is in an abnormal state; or
the network-side device configuring or pre-configuring the terminal module to initiate radio link establishment comprises at least one of the following:
the terminal module initiating a connection establishment procedure based on first pre-configuration information sent by the network-side device; or
the terminal module failing to receive side control information within a preset time duration, and the terminal module being configured, before entering the first state, with wireless channels or resources for receiving the side control information.

20. The non-transitory computer-readable storage medium according to claim 18, wherein performing the radio link establishment method further comprises:
performing, by the terminal module, a first operation when determining to initiate radio link establishment, the first operation comprising at least one of the following:
controlling the forwarding unit to cease a forwarding behavior;
ceasing, by the forwarding unit, an uplink forwarding behavior or a downlink forwarding behavior when sending a signal to the network-side device; or
ceasing, by the forwarding unit, an uplink forwarding behavior or a downlink forwarding behavior when receiving a transmission signal from the network-side device.
